(19) United States
(12) Patent Application Publication
(10) Pub. No.: US 2014/0089445 A1
(43) Pub. Date: Mar. 27, 2014

(54) STORAGE APPARATUS, SETTING METHOD, AND COMPUTER PRODUCT

(71) Applicant: Fujitsu Limited, Kawasaki-shi (JP)

(72) Inventor: Takuma Suzuki, Kawasaki (JP)

(73) Assignee: Fujitsu Limited, Kawasaki-shi (JP)

(21) Appl. No.: 13/953,905

(22) Filed: Jul. 30, 2013

(30) Foreign Application Priority Data
Sep. 27, 2012 (JP) 2012-215188

(51) Int. Cl. G06F 3/06; H04L 29/08

(52) U.S. Cl. CPC G06F 3/0647; H04L 29/08549
USPC 709/212

(57) ABSTRACT

A first storage apparatus to which data stored in a second storage apparatus connected to the first storage apparatus is migrated via a network, includes a memory unit that stores first identification information of a first information processing apparatus connected to the second storage apparatus via the network; and a processor configured to issue to the second storage apparatus, a command that is issued from the first information processing apparatus to the second storage apparatus, using the first identification information stored in the memory unit, and acquire from the second storage apparatus, a response to the command; and associate based on the response and set in the first storage apparatus, the first identification information and parameter information of the first information processing apparatus corresponding to the command.

### CROSS REFERENCE TO RELATED APPLICATIONS

This application is based upon and claims the benefit of priority of the prior Japanese Patent Application No. 2012-215188, filed on Sep. 27, 2012, the entire contents of which are incorporated herein by reference.

### FIELD

The embodiments discussed herein are related to a storage apparatus, a setting method, and a computer product.

### BACKGROUND

When a storage apparatus in use deteriorates after a long period of service, replacement work is executed to replace the storage apparatus in use with a new storage apparatus. In the replacement work, data is migrated from the storage apparatus in use to the new storage apparatus. For example, a method of migrating data directly from one storage apparatus to another storage apparatus that are connected to each other is known as a data migration method.

In the replacement work, to start operation by the new storage apparatus, setting work is executed to set to the new storage apparatus, information for a host apparatus connected to the storage apparatus in use. Information for the host apparatus includes, for example, information related to a response from the storage apparatus to a command from the host apparatus.

Related prior art includes, for example, a technique such that a pre-switching system sends user data and take-over information to a post-switching system which stores therein the incoming user data and take-over information, and a technique such that a first storage apparatus sends target information set in a first logical volume thereof to a second storage apparatus which sets a target in a second logical unit thereof using the incoming target information.

For examples, refer to Japanese Laid-Open Patent Publication Nos. 2010-079678 and 2005-353035.

The conventional techniques, however, pose a problem in that setting work of setting information for an information processing apparatus (e.g., host apparatus) connected to a storage apparatus in use to a new storage apparatus consumes a great deal of time during storage apparatus replacement work.

### SUMMARY

According to an aspect of an embodiment, a first storage apparatus to which data stored in a second storage apparatus connected to the first storage apparatus is migrated via a network, includes a memory unit that stores first identification information of a first information processing apparatus connected to the second storage apparatus via the network; and a processor configured to issue to the second storage apparatus, a command that is issued from the first information processing apparatus to the second storage apparatus, using the first identification information stored in the memory unit, and acquire from the second storage apparatus, a response to the command; and associate based on the response and set in the first storage apparatus, the first identification information and parameter information of the first information processing apparatus corresponding to the command.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a setting method according to an embodiment;

FIG. 2 is an explanatory diagram of an example of a system configuration of a storage system 200;

FIG. 3 is a block diagram of an example of a hardware configuration of a RAID apparatus;

FIG. 4 is an explanatory diagram of an example of a migration setting file;

FIG. 5 is an explanatory diagram of an example of the contents of a host table;

FIG. 6 is an explanatory diagram of an example of the contents of the LUN masking table;

FIG. 7 is an explanatory diagram of an example of the contents of a host-specific setting table;

FIG. 8 is a block diagram of an example a functional configuration of a data-migration destination RAID apparatus #D;

FIGS. 9, 10, 11, 12, 13, 14, 15, and 16 are explanatory diagrams of a specific example of setting of host-specific setting information by the data-migration destination RAID apparatus #D;

FIG. 17 is a flowchart of an example of a procedure of a data migration process by the data-migration destination RAID apparatus #D; and

FIG. 18 is a sequence diagram of an example of a procedure of a process of setting the host-specific setting table 700.

### DESCRIPTION OF EMBODIMENTS

Embodiments of a storage apparatus, setting method, and setting program will be described in detail with reference to the accompanying drawings.

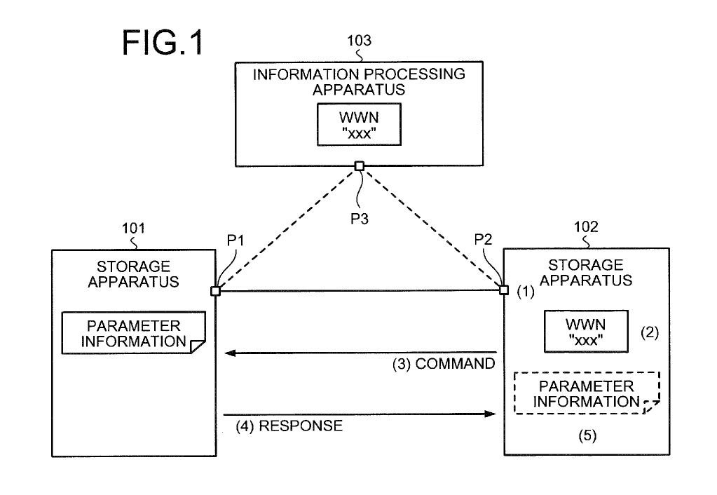

FIG. 1 is an explanatory diagram of an example of a setting method according to the embodiments. In FIG. 1, each storage apparatus 101 and 102 is a computer having one or multiple of storage devices. A storage device includes a memory medium, such as a hard disk, optical disk, and flash memory. An information processing apparatus 103 is a computer that connects to the storage apparatuses 101 and 102 and uses the memory areas. The information processing apparatus 103 is, for example, a server.

When a storage apparatus in use deteriorates after a long period of service, replacement work may be executed to replace the storage apparatus in use with a new storage apparatus. A case is assumed where the storage apparatus 101 is replaced with the storage apparatus 102. In this case, data carried by the storage apparatus 101 is migrated to the storage apparatus 102, and parameter information for the information processing apparatus 103 connected to the storage apparatus 102 serving as a data-migration destination is set to the storage apparatus 102 serving as the data-migration destination.

The parameter information is the information that is set onto the storage apparatus 102 serving as the data-migration destination to start operation by the storage apparatus 102 serving as the data-migration destination. For example, the parameter information is information for generating a response to a command issued from the information processing apparatus 103.

Commands issued from the information processing apparatus 103 include, for example, a command requesting device information of a storage device including a memory area (volume) assigned to the information processing apparatus 103, and a command requesting path information of a communication path used for communication between the storage apparatus 102 serving as the data-migration destination and the information processing apparatus 103.

Parameter information is different for each information processing apparatus 103 connected to the storage apparatus 102 serving as the data-migration destination, and is therefore set for each information processing apparatus 103. For this reason, the parameter information on each information processing apparatus 103 is set manually on the storage apparatus 102 serving as the data-migration destination, which consumes a great deal of time. If parameter information setting work is performed erroneously, it may cause problems of a path switching error, a volume recognition failure by the information processing apparatus 103, etc. The parameter information setting work, therefore, imposes a high work load on a worker.

It is conceivable, for example, that when data migration is performed, a data-migration source storage apparatus from which data is migrated and a data-migration destination storage apparatus to which data is migrated autonomously communicate with each other to set parameter information set in the data-migration source storage apparatus onto the data-migration destination storage apparatus. However, this requires providing both the data-migration source storage apparatus and the data-migration destination storage apparatus with a specific function of executing an operation for setting the parameter information, thus increasing the burden on the worker as well as cost.

According to the embodiments, using identification information of the information processing apparatus 103, the data-migration destination storage apparatus 102 issues a command to the data-migration source storage apparatus 101 and acquires a response to the command. In this manner, the data-migration destination storage apparatus 102 emulating the information processing apparatus 103 obtains the parameter information from the data-migration source storage apparatus 101 and thereby, automates setting of parameter information of the information processing apparatus 103.

An example of a setting process by the storage apparatus 102 will hereinafter be described taking a case where the data-migration destination storage apparatus 102 sets parameter information carried by the migration source storage apparatus 101, onto the destination storage apparatus 102.

In the example of FIG. 1, the worker, such as a customer engineer (CE), first breaks a connection between the storage apparatus 101 and the information processing apparatus 103. Breaking the connection means, for example, breaking the physical connection between the storage apparatus 101 and the information processing apparatus 103 by removing a communication line or breaking the logical connection between the storage apparatus 101 and the information processing apparatus 103. The worker then connects a port P1 of the storage apparatus 101 to a port P2 of the storage apparatus 102.

The worker inputs a setting process start instruction to the storage apparatus 102. The setting process start instruction is input by the worker who operates a notebook personal computer (PC) or presses an operation button on the storage apparatus 102.

(1) Upon receiving the setting process start instruction, the storage apparatus 102 sets the port P2 connected to the storage apparatus 101 to an initiator mode. The initiator mode is an operation mode in which a small computer system interface (SCSI) command can be issued. SCSI represents an interface standard. In the following explanation, a port set to the initiator mode may be referred to as “initiator port”.

(2) The storage apparatus 102 sets identification information of the information processing apparatus 103 as identification information of the initiator port P2. The identification information of the information processing device 103 is, for example, the world wide name (WWN) “xxx” of a port P3 of the information processing apparatus 103 that has been connected to the port P1 of the storage apparatus 101.

Through this process, by issuing from the initiator port P2, an SCSI command including the WWN “xxx” of the information processing apparatus 103, the storage apparatus 102 can receive from the storage apparatus 101, a response to the command.

(3) The storage apparatus 102 thus issues the SCSI command including the WWN “xxx” of the information processing apparatus 103, to the storage apparatus 101 via the initiator port P2. In this manner, the storage apparatus 102 can issue to the storage apparatus 101, a SCSI command as if issued from the information processing apparatus 103.

(4) Upon receiving the SCSI command from the storage apparatus 102, the storage apparatus 101 generates a response to the received SCSI command, based on parameter information related to the information processing apparatus 103 that is set in the storage apparatus 101. The storage apparatus 101 then sends the response to the storage apparatus 102.

(5) Upon receiving the response from the storage apparatus 101, the storage apparatus 102 generates parameter information related to the information processing apparatus 103 based on the received response. The storage apparatus 102 sets the generated parameter information related to the information processing apparatus 103, onto the storage apparatus 102.

In this manner, using identification information of the information processing apparatus 103, the storage apparatus 102 can issue an SCSI command to the data-migration source storage apparatus 101 and acquire a response to the command. The storage apparatus 102 can generate parameter information related to the information processing apparatus 103, based on the response acquired from the data-migration source storage apparatus 101, and set the generated parameter information onto the storage apparatus 102.

Thus, the data-migration destination storage apparatus 102 emulating the information processing apparatus 103, extracts the parameter information from the data-migration source storage apparatus 101, thereby automating the setting of the parameter information of the information processing apparatus 103. As a result, work load on the worker during replacement work is reduced and erroneous setting of the parameter information is prevented, making the replacement work more efficient.

It is not necessary to provide the data-migration source storage apparatus 101 with a new function. Therefore, the burden on the worker and cost can be reduced, compared to a case where both the data-migration source and data-migration destination storage apparatuses are provided with a function for automating the setting of parameter information.

When data migration from the storage apparatus 101 to the storage apparatus 102 and setting of parameter information for the information processing apparatus 103 onto the storage device 102 are completed, for example, the worker connects the port P2 of the storage apparatus 102 to the port P3 of the information processing apparatus 103. As a result, the information processing apparatus 103 can use the storage apparatus 102 in the same manner as the storage apparatus 101 does.

In the following explanation, a case will be described where the storage apparatus (e.g., storage apparatuses 101 and 102 of FIG. 1) is provided as a RAID (redundant arrays of independent disks) apparatus that ensures data redundancy using multiple disk devices.

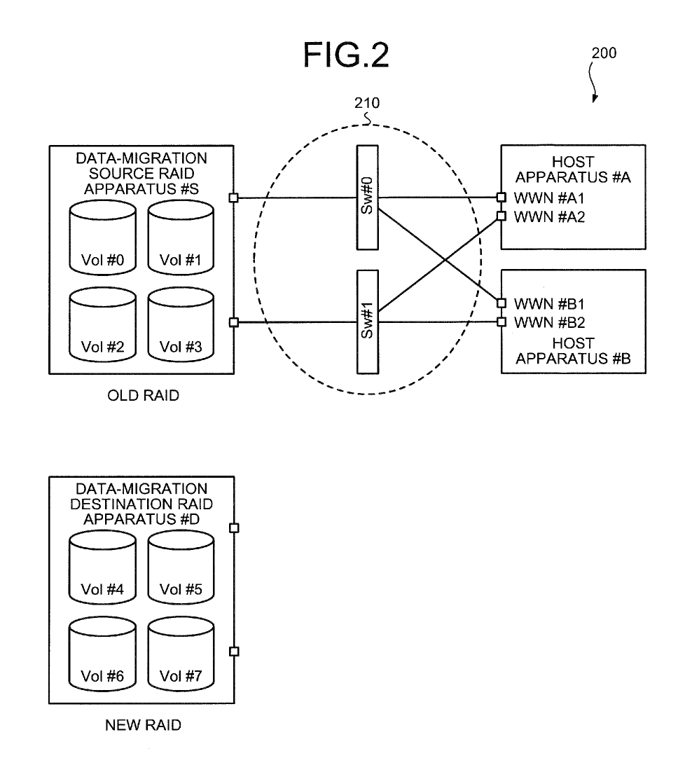

FIG. 2 is an explanatory diagram of an example of a system configuration of a storage system 200. In FIG. 2, a storage system 200 includes a data-migration source RAID apparatus #S, a data-migration destination RAID apparatus #D, a host apparatus #A, and a host apparatus #B. The data-migration source RAID apparatus #S and the data-migration destination RAID apparatus #D are equivalent to, for example, the storage apparatus 101 and the storage apparatus 102 of FIG. 1. Each of the host apparatuses #A and #B is equivalent to, for example, the information processing apparatus 103 of FIG. 1.

The data-migration source RAID apparatus #S (“Old RAID” in FIG. 2) is connected to the host apparatuses #A and #B via a network 210. In the example of FIG. 2, the network 210 is made up of signal lines, a switch Sw#0, and a switch Sw#1. The switches Sw#0 and Sw#1 are devices that relay data and are provided as, for example, fiber channel (FC) switches.

The data-migration source RAID apparatus #S forms logical volumes Vol#0 to Vol#3 using disk devices in the data-migration source RAID apparatus #S. The data-migration source RAID apparatus #S assigns the logical volumes Vol#0 and Vol#1 to the host apparatus #A and allows the host apparatus #A to use the logical volumes Vol#0 and Vol#1. The data-migration source RAID apparatus #S assigns the logical volumes Vol#2 and Vol#3 to the host apparatus #B and allows the host apparatus #B to use the logical volumes Vol#2 to Vol#3. In the data-migration source RAID apparatus #S, parameter information of each of the host apparatuses #A and #B (hereinafter “host-specific setting information”) is set.

The host apparatus #A has two ports, and stores WWN “#A1 and #A2” as identification information of the respective ports. The host apparatus #A is connected to the data-migration source RAID apparatus #S via the network 210. The host apparatus #A uses the logical volumes Vol#0 and Vol#1 in the data-migration source RAID apparatus #S.

The host device #B has two ports, and stores WWN “#B1 and #B2” as identification information of the respective ports. The host device #B is connected to the data-migration source RAID apparatus #S via the network 210. The host device #B uses the logical volumes Vol#2 and Vol#3 in the data-migration source RAID apparatus #S.

The data-migration destination RAID apparatus #D (“New RAID” in FIG. 2) forms logical volumes Vol#4 to Vol#7 using disk devices in the data-migration destination RAID apparatus #D. When replacement work of replacing the data-migration source RAID apparatus #S with the data-migration destination RAID apparatus #D is performed, the worker breaks the connection between the data-migration source RAID apparatus #S and the host devices #A and #B and connects the data-migration source RAID apparatus #S to the data-migration destination RAID apparatus #D.

The data-migration destination RAID apparatus #D then migrates data carried by the data-migration source RAID apparatus #S to the data-migration destination RAID apparatus #D, and sets host-specific setting information of the host apparatuses #A and #B set in the data-migration source RAID apparatus #S, onto the data-migration destination RAID apparatus #D. When the data-migration destination RAID apparatus #D has completed the data migration and setting of the host-specific setting information, the worker breaks the connection between the data-migration source RAID apparatus #S and the data-migration destination RAID apparatus #D and connects the data-migration destination RAID apparatus #D to the host devices #A and #B.

While the example of FIG. 2 is described as the case of using two host apparatuses, this is not the only case. Three or more hot apparatuses may be used.

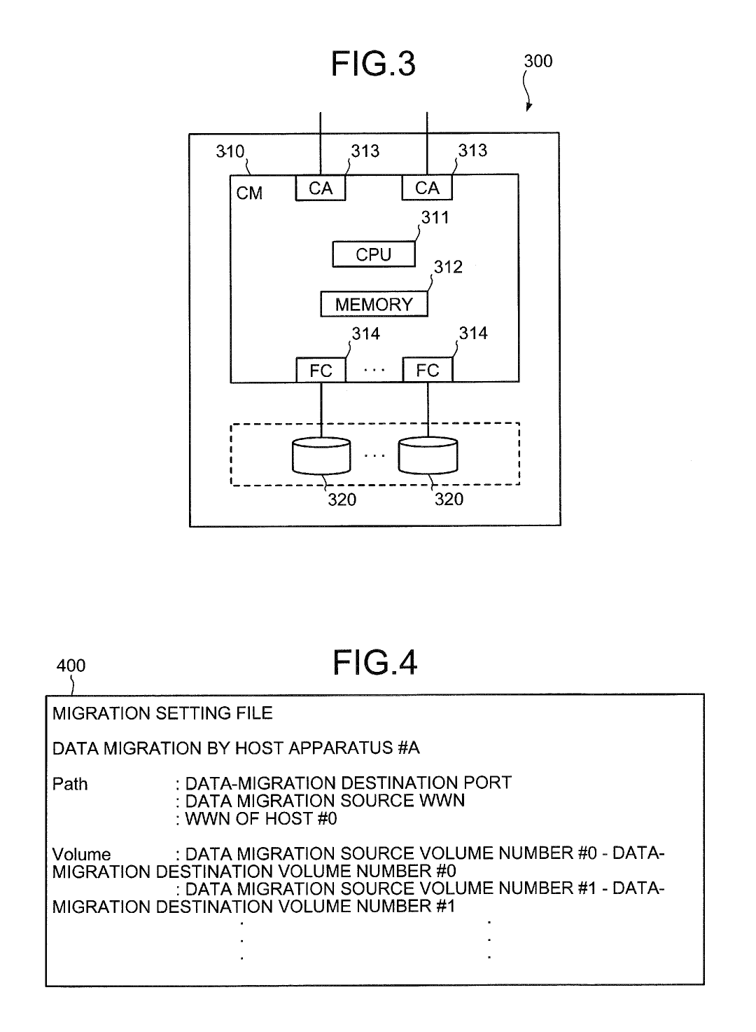

FIG. 3 is a block diagram of an example of a hardware configuration of the RAID apparatus. In FIG. 3, the RAID apparatus (the data-migration source RAID apparatus #S and data-migration destination RAID apparatus #D of FIG. 2) includes a control module (CM) 310 and multiple disk devices 320. The CM 310 has a central processing unit (CPU) 311, memory 312, channel adaptors (CAs) 31.3, and FCs 314.

The CPU 311 governs overall control of the CM 310. The memory 312 includes, for example, read-only memory (ROM), random access memory (RAM), and flash ROM. For example, the flash ROM stores programs such as an OS and firmware. The ROM stores application programs. The RAM is used as a work area of the CPU 311. Programs stored in the memory 312 are loaded onto the CPU 311, whereby encoded processes are executed by the CPU 311.

Each CA 313 controls interface with an external apparatus (e.g., a host apparatus). Each FC 314 controls interface with each disk device 320. The disk device 320 implements a logical volume to/from which data is written or read by the host apparatus. The disk device 320 is, for example, a magnetic disk device.

While FIG. 3 depicts a case where the RAID apparatus includes one CM 310, this is not the only case. For example, the RAID apparatus may include two or more CMs 310. While FIG. 3 depicts a case where the CM 310 has two CAs 313, this is not the only case. For example, the CM 310 may have three or more CAs 313 and in the same manner, may have three or more FCs 314.

An example of a migration setting will be described with reference to FIG. 4. The migration setting file is, for example, input by the worker into the data-migration destination RAID apparatus #D and is stored in the memory 312. The data-migration destination RAID apparatus #D) refers to the migration setting file when data is migrated from the data-migration source RAID apparatus #S to the data-migration destination RAID apparatus #D or when host-specific setting information is to be identified.

FIG. 4 is an explanatory diagram of an example of the migration setting file. A migration setting file 400 includes information related to data migration for each host. In the example of FIG. 4, the migration setting file 400 includes information related to data migration for the host apparatus #A.

Information related to data migration indicates, for example, the number for a port of the data-migration destination RAID apparatus #D connected to the host apparatus #A. Information related to data migration indicates, for example, the WWN of the data-migration source RAID apparatus #S and the WWN of the host apparatus #A. Information related to data migration indicates, for example, a combination of the number for a logical volume in the data-migration source RAID apparatus #S that has been assigned to the host apparatus #A and the number for a logical volume in the data-migration destination RAID apparatus #D that corresponds to the above logical volume. The logical volume is a section of given memory area. The number for the logical volume is, for example, a logical unit number (LUN).

Through this migration setting file, the data-migration destination RAID apparatus #D can identify the WWN of a host apparatus that is used when data is migrated from the data-migration source RAID apparatus #S to the data-migration destination RAID apparatus #D. The data-migration destination RAID apparatus #D can identify the WWN of the host apparatus used for acquiring host-specific setting information set in the data-migration source RAID apparatus #S and the WWN of the data-migration destination RAID apparatus #D. The data-migration destination RAID apparatus #D can determine which logical volume's data in the data-migration source RAID apparatus #S is to be migrated to which volume in the data-migration destination RAID apparatus #D. The data-migration destination RAID apparatus #D can determines which logical volume is to be assigned to the host apparatus #A.

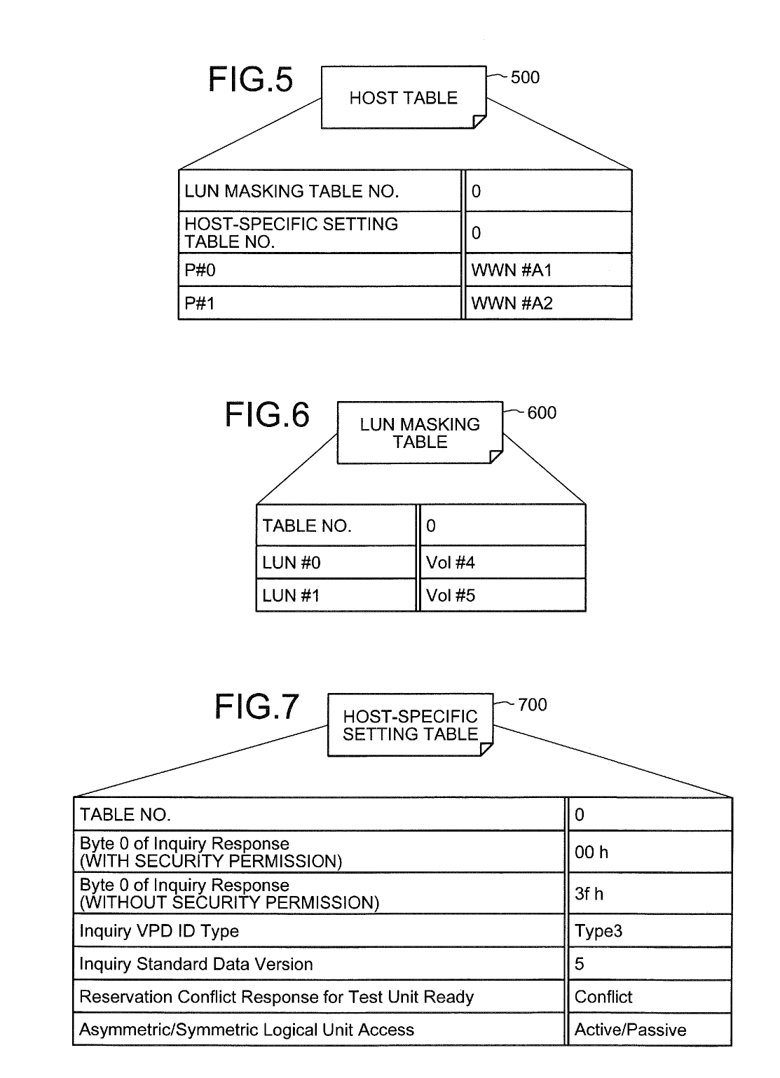

An example of the contents of a host table will be described with reference to FIG. 5. The host table is implemented by, for example, the memory 312. The host table is generated by the data-migration destination RAID apparatus #D for each host apparatus that uses a memory area of the data-migration destination RAID apparatus #D.

FIG. 5 is an explanatory diagram of an example of the contents of the host table. As depicted in FIG. 5, a host table 500 has a LUN masking table no. field and a host-specific setting table no. field, a port P#0 field, and a port P#1 field that are associated with the LUN masking table no. field. Information is set in each field to form a record.

The LUN masking table no. field stores an identifier for a LUN masking table corresponding to a host apparatus. The host-specific setting table no. field stores an identifier for a host-specific setting table corresponding to the host apparatus. The port P#0 field stores a WWN set on the port P#0 of the data-migration destination RAID apparatus #D. The port P#1 field stores a WWN set on the port P#1 of the data-migration destination RAID apparatus #D.

This host table allows the data-migration destination RAID apparatus #D to identify a LUN masking table corresponding to a given host apparatus and to identify a host-specific setting table corresponding to the given host apparatus.

An example of the contents of the LUN masking table will be described with reference to FIG. 6. The LUN masking table is implemented by, for example, the memory 312. The LUN masking table stores the number for a logical volume assigned to a host apparatus. The LUN masking table is generated by the data-migration destination RAID apparatus #D for each of multiple host apparatuses that use a memory area the data-migration destination RAID apparatus #D has.

FIG. 6 is an explanatory diagram of an example of the contents of the LUN masking table. As depicted in FIG. 6, a LUN masking table 600 has a table no. field, and a LUN#0 field and a LUN#1 field that are associated with the table no. field. Information is set in each field to form a record.

The table no. field stores an identifier corresponding to a host apparatus. The LUN#0 field stores the LUN of a logical volume of the data-migration destination RAID apparatus #D to which data carried by a logical volume with a LUN “#0” assigned by the data-migration source RAID apparatus #S to the host apparatus is to be migrated. The LUN#1 field stores the LUN of a logical volume of the data-migration destination RAID apparatus #D) to which data carried by a logical volume with a LUN “#1” assigned by the data-migration source RAID apparatus #S to the host apparatus is to be migrated. Based on the contents, the data-migration destination RAID apparatus #D can identify a logical volume assigned to the host apparatus #A.

An example of the contents of the host-specific setting table will be described with reference to FIG. 7. The host-specific setting table is implemented by, for example, the memory 312. The host-specific setting table stores host-specific setting information set in the data-migration source RAID apparatus #S, the host-specific setting information being identified by the data-migration destination RAID apparatus #D. The host-specific setting table is generated by the data-migration destination RAID apparatus #D for each of multiple host apparatuses that use a memory area of the data-migration destination RAID apparatus #D.

FIG. 7 is an explanatory diagram of an example of the contents of the host-specific setting table. As depicted in FIG. 7, a host-specific setting table 700 has a table no. field and a byte 0 of inquiry response (with security permission) field associated with the table no. field. The host-specific setting table 700 further has a byte 0 of inquiry response (without security permission) field associated with the table no. field. The host-specific setting table 700 further has an inquiry VPD ID type field and an inquiry standard data version field, which are associated with the table no. field.

The host-specific setting table 700 further has a reservation conflict response for test unit ready field associated with the table no. field. The host-specific setting table 700 further has an asymmetric/symmetric logical unit access field associated with the table no. field. In the host-specific setting table 700, information is set in each field to form each record.

The table no. field stores an identifier corresponding to a host apparatus. The byte 0 of inquiry response (with security permission) field stores device information that is to be included in inquiry data when an inquiry (standard) command is issued from a host apparatus with security permission. The device information is included, for example, in the byte 0 part of the inquiry data.

The inquiry (standard) command is a command that includes information (e.g., LUN) for specifying a logical volume and that requests device information of a device (e.g., disk device 320) in the data-migration source RAID apparatus #S that implements the logical volume indicated by the information. The inquiry (standard) command further serves as a command that requests information indicating the version of an SCSI. The inquiry data is a response to an inquiry (standard) command. The byte 0 part is a part that includes device information, representing a 1-byte header portion of the inquiry data. The host apparatus with security permission is a host apparatus permitted by the data-migration destination RAID apparatus #D to use the logical volume of the data-migration destination RAID apparatus #D. The device information is indicated as Peripheral qualifier and peripheral device type.

A peripheral qualifier is 3-bit data indicating the status of a device that implements a logical volume specified by an inquiry (standard) command. A peripheral qualifier is, for example, “000”, “001”, or “011”. “000” indicates that the type of the device that implements the logical volume specified by the inquiry (standard) command is a type indicated by peripheral device type. “001” indicates that the type of the device that implements the logical volume specified by the inquiry (standard) command is the type indicated by peripheral device type but the device that implements the logical volume is actually not connected. “011” indicates that the logical volume specified by the inquiry (standard) command is actually not present.

A peripheral device type is 5-bit data indicating the type of device that implements a logical volume specified by an inquiry (standard) command. A peripheral device type is, for example, “00000” or “00001”. “00000” indicates a direct access device. “00001” indicates a sequential access device.

The byte 0 of inquiry response (without security permission) field stores device information included in the byte 0 part of inquiry data when an inquiry (standard) command is issued from a host apparatus without security permission. A host apparatus without security permission is a host apparatus not permitted by the data-migration destination RAID apparatus #D to use a logical volume thereof.

The Inquiry VPD ID Type field stores a VPD ID type included in a response to an inquiry (page 83h) command issued from a host apparatus. The inquiry (page 83h) command is the command requesting device information of the data-migration source RAID apparatus #S. VPD ID Type is a form of device information. The inquiry standard data version field stores the version of the SCSI in the data-migration source RAID apparatus #S.

In a given case, after a logical volume is reserved by a given host apparatus, a test unit ready command originally issued from a different host apparatus may be issued. The reservation conflict response for test unit ready field stores the result of a determination of whether to send reservation conflict as a response to the command issued in the above case. A test unit ready command is a command requesting information indicating whether the status of a logical volume is ready. A status of ready means that the logical volume is ready for the writing of data thereto and the reading of data therefrom.

In another case, a report target port groups command originally issued from a given host apparatus may be issued. The asymmetric/symmetric logical unit access field stores information indicating a method of using a communication path to the host apparatus, the information being included in a response to the command issued in the above case. A report target port groups command is a command requesting information indicating a method of using a communication path to the host apparatus. The method of using a communication path is, for example, a method of determining which communication path is to be used for data transmission/reception when multiple communication paths are present.

When a host apparatus issues an SCSI command to the data-migration destination RAID apparatus #D, the data-migration destination RAID apparatus #D can send a response to the host apparatus according to host-specific setting information stored in the host-specific setting table 700.

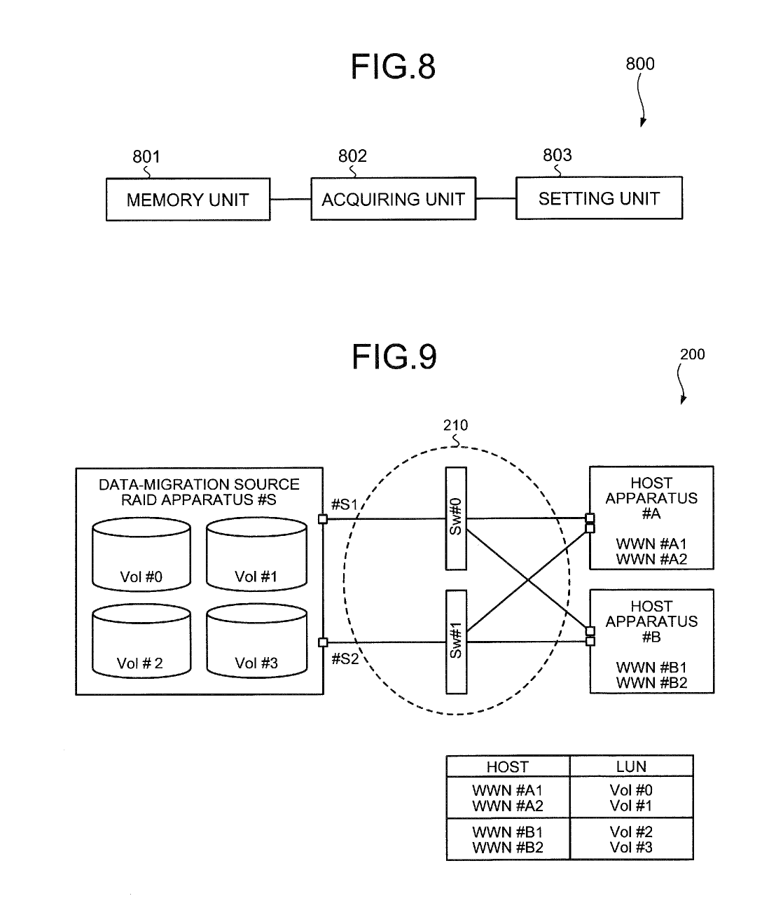

An example of a functional configuration of the RAID apparatus will be described with reference to FIG. 8. The data-migration destination RAID apparatus #D will be described as an example of the RAID apparatus. FIG. 8 is a block diagram of an example a functional configuration of the data-migration destination RAID apparatus #D. In FIG. 8, the data-migration destination RAID apparatus #D includes a memory unit 801, an acquiring unit 802, and a setting unit 803. The data-migration destination RAID apparatus #D is the RAID apparatus to which data stored in the RAID apparatus serving as a data migration source (e.g., data-migration source RAID apparatus #S) is migrated.

The memory unit 801 stores identification information of a host apparatus connected to the data-migration source RAID apparatus via the network 210. The data-migration source RAID apparatus is a storage apparatus replaced with the data-migration destination RAID apparatus through replacement work and is, for example, the data-migration source RAID apparatus #S.

The host apparatus is an information processing apparatus that writes and reads data to and from the RAID apparatus. The host apparatus is an apparatus with security permission and is, for example, the host apparatus #A. Identification information indicates, for example, a WWN, but does not indicate only the WWN. For example, the identification information may indicate an SCSI name.

A function of the memory unit 801 is implemented by the migration setting file 400 stored in the memory 312 of FIG. 3. As a result, using identification information stored in the memory unit 801, the acquiring unit 802 can issue an SCSI command, the source of issue of which is indicated as a host apparatus with security permission, and can acquire a response, the address of which is indicated as the host apparatus with security permission.

The memory unit 801 may store different identification information different from identification information of a host device. Different identification information is identification information of an apparatus without security permission and indicates, for example, the WWN of the data-migration source RAID apparatus #D. Thus, using different identification information stored in the memory unit 801, the acquiring unit 802 can issue an SCSI command, the source of issue of which is indicated as an apparatus without security permission and can acquire a response, the address of which is indicated as the apparatus without security permission.

Using the identification information stored in the memory unit 801, the acquiring unit 802 issues to the data-migration source RAID apparatus #S, a command originally issued from the host apparatus to the data-migration source RAID apparatus #S and acquires a response to the command, from the data-migration source RAID apparatus #S. The command may be, for example, an SCSI command, but is not limited to an SCSI command.

A function of the acquiring unit 802 is implemented by, for example, causing the CM 310 to execute a program stored in the memory 312 of FIG. 3 or through the CAs 313. Thus, the setting unit 803 can identify host-specific setting information in the data-migration source RAID apparatus #S from a response that is generated based on the host-specific setting information in the data-migration source RAID apparatus #S. The host-specific setting information is, for example, the contents of each field of the host-specific setting information table 700, which are peripheral qualifier and peripheral device type.

The acquiring unit 802 may issue the above command to the data-migration source RAID apparatus #S, using the different identification information stored in the memory unit 801, and acquires a response to the command, from the data-migration source RAID apparatus #S. Thus, the setting unit 803 can identify host-specific setting information in the data-migration source RAID apparatus #S, from a response that is generated based on the host-specific setting information of an apparatus without security permission in the data-migration source RAID apparatus #S.

Based on the response acquired by the acquiring unit 802, the setting unit 803 associates the host-specific setting information corresponding to the command with the identification information, and sets the host-specific setting information in the data-migration destination RAID apparatus #D. A function of the setting unit 803 is implemented by, for example, causing the CM 310 to execute a program stored in the memory 312 of FIG. 3. In this manner, the setting unit 803 can set in the data-migration destination RAID apparatus #D, the host-specific setting information set in the data-migration source RAID apparatus #S. As a result, after being connected to the host apparatus, the data-migration destination RAID apparatus #D can generate a response to a command issued from the host apparatus, according to the host-specific setting information set in the data-migration destination RAID apparatus #D.

As describe above, the data-migration destination RAID apparatus #D implements the process of setting host-specific setting information into the data-migration destination RAID apparatus #D, through the memory unit 801, the acquiring unit 802, and the setting unit 803. A specific example of the process of setting host-specific setting information implemented by the memory unit 801, the acquiring unit 802, and the setting unit 803 will hereinafter be described. The function of the memory unit 801 has been described above, and is therefore omitted in the following description.

Using the WWN “#A1” of the host apparatus #A, the acquiring unit 802, for example, may issue to the data-migration source RAID apparatus #S, a command requesting device information of a storage device including a memory area assigned to the host apparatus #A, among the memory areas of the data-migration source RAID apparatus #S. The acquiring unit 802 acquires from the data-migration source RAID apparatus #S, a response to the command.

The memory area assigned to the host apparatus #A is a logical volume assigned to the host apparatus #A by the data-migration source RAID apparatus #S. The storage device including the memory area is, for example, a device implementing the logical volume (e.g., the disk device 320). The device information of the storage device is, for example, peripheral qualifier and peripheral device type. The command requesting the device information is, for example, an inquiry (standard) command.

For example, the acquiring unit 802 extracts from the migration setting file 400, the WWN “#A1” of the host apparatus #A that has been using the data-migration source RAID apparatus #S, and sets the WWN “#A1” of the host apparatus #A onto an initiator port in the data migration destination RAID apparatus #D. The acquiring unit 802 then issues an inquiry (standard) command including the WWN “#A1” to the data-migration source RAID apparatus #S. The acquiring unit 802 acquires inquiry data, which is a response to the command, from the data-migration source RAID apparatus #S.

In this manner, the acquiring unit 802 can acquire the inquiry data that is the response to the inquiry (standard) command issued from the host apparatus #A with security permission.

In this case, the setting unit 803 acquires, for example, data of the byte 0 part of the inquiry data that is acquired by the acquiring unit 802 as the result of issue of the inquiry (standard) command including the WWN “#A1” of the host apparatus #A by the acquiring unit 802. The setting unit 803 then identifies the acquired data of the byte 0 part, as data set in the data-migration source RAID apparatus #S as host-specific setting information for a case of issue of a command from the host apparatus #A with security permission. The setting unit 803 then sets the acquired data in the byte 0 of inquiry response (with Security Permission) field of the host-specific setting table 700.

In this manner, when the host apparatus #A issues the inquiry (standard) command to the data-migration destination RAID apparatus #D, the data-migration destination RAID apparatus #D can generate inquiry data that includes the set host-specific setting information and send the generated inquiry data to the host apparatus #A. Thus, the data-migration destination RAID apparatus #D can send a response to the host apparatus #A in the same manner as the data-migration source RAID apparatus #S does.

Using the WWN “#A1” of the host apparatus #A, the acquiring unit 802 may issue to the data-migration source RAID apparatus #S, a command requesting information of the standard of an interface used for communication between the data-migration source RAID apparatus #S and the host device #A. The acquiring unit 802 acquires a response to the command, from the data-migration source RAID apparatus #S. The standard of the interface used for communication is, for example, SCSI. The command requesting information of the standard of the interface is, for example, an inquiry (standard) command.

For example, the acquiring unit 802 sets the WWN “#A1” of the host apparatus #A onto an initiator port in the data migration destination RAID apparatus #D. The acquiring unit 802 then issues an inquiry (standard) command including the WWN “#A1” to the data-migration source RAID apparatus #S. The acquiring unit 802 acquires inquiry data, which is a response to the command, from the data-migration source RAID apparatus #S. In this manner, the acquiring unit 802 can acquire the inquiry data used for identifying host-specific setting information.

In this case, the setting unit 803 extracts, for example, data of American National Standard Institute (ANSI) from the inquiry data. The setting unit 803 identifies the version of the SCSI set in the data-migration source RAID apparatus #S as host-specific setting information, based on the extracted data. The setting unit 803 then sets the identified version of the SCSI in the inquiry standard data version field of the host-specific setting table 700. Thus, the data-migration destination RAID apparatus #D can communicate with the host apparatus #A, by referring to the version of the SCSI used by the host apparatus #A and the data-migration source RAID apparatus #S for mutual communication.

Using the WWN “#A1” of the host apparatus #A, the acquiring unit 802, for example, may issue to the data-migration source RAID apparatus #S, a command requesting device information of the data-migration source RAID apparatus #S. The acquiring unit 802 acquires a response to the command, from the data-migration source RAID apparatus #S. The device information of the data-migration source RAID apparatus #S is, for example, the vender ID and the product ID for the data-migration source RAID apparatus #S. The vender ID is an identifier indicating the manufacturer of the data-migration source RAID apparatus #S. The product ID is the product number for the data-migration source RAID apparatus #S.

For example, the acquiring unit 802 sets the WWN “#A1” of the host apparatus #A onto the initiator port in the data migration destination RAID apparatus #D. The acquiring unit 802 then issues an inquiry (page 83h) command including the WWN “#A1” to the data-migration source RAID apparatus #S. The acquiring unit 802 then acquires inquiry data, which is a response to the command, from the data-migration source RAID apparatus #S. In this manner, the acquiring unit 802 can acquire the inquiry data used for identifying host-specific setting information.

In this case, the setting unit 803 identifies, for example, the form of device information of the data-migration source RAID apparatus #S (which may be referred to as #VPD ID Type” in the following explanation) set in the data-migration source RAID apparatus #S, based on the inquiry data. The setting unit 803 sets the identified VPD ID Type in the Inquiry VPD ID Type field of the host-specific setting table 700. As a result, when the host apparatus #A issues an inquiry (page 83h) command, the data-migration destination RAID apparatus #D can generate inquiry data including the device information of the data-migration destination RAID apparatus #D, according to the set VPD ID Type. The data-migration destination RAID apparatus #D sends the generated inquiry data to the host apparatus #A.

The acquiring unit 802, for example, may issue a command requesting information of a communication path used for communication between the data-migration source RAID apparatus #S and the host device #A, to the data-migration source RAID apparatus #S, using the WWN “#A1” of the host apparatus #A. The acquiring unit 802 acquires a response to the command, from the data-migration source RAID apparatus #S. The information of the communication path is information indicating a method of using a communication path, which is information indicating which communication path is to be used for data transmission/reception when, for example, multiple communication paths from the data-migration source RAID apparatus #S to the host device #A are present.

For example, the acquiring unit 802 sets the WWN “#A1” of the host apparatus #A onto the initiator port in the data migration destination RAID apparatus #D. The acquiring unit 802 then issues a report target port groups command including the WWN “#A1” to the data-migration source RAID apparatus #S. The acquiring unit 802 then acquires asymmetric access state data, which is a response to the command, from the data-migration source RAID apparatus #S. In this manner, the acquiring unit 802 can acquire the asymmetric access state data used for identifying host-specific setting information.

In this case, the setting unit 803 identifies, for example, a method of using a communication path set in the data-migration source RAID apparatus #S, based on the asymmetric access state data. The setting unit 803 then sets the identified method of using the communication path in the asymmetric/symmetric logical unit access field of the host-specific setting table 700. As a result, the data-migration destination RAID apparatus #D can transmit/receive data to/from the host apparatus #A, according to the set method of using the communication path.

The acquiring unit 802 may issue the above command to the data-migration source RAID apparatus #S, using different identification information stored in the memory unit 801. The acquiring unit 802 acquires a response to the command, from the data-migration source RAID apparatus #S. The command is the inquiry (standard) command, inquiry (page 83h) command, or the report target port group command.

For example, the acquiring unit 802 sets the WWN “#N” of the data-migration destination RAID apparatus #D onto the initiator port in the data migration destination RAID apparatus #D. The acquiring unit 802 then issues an inquiry (standard) command including the WWN “#N” to the data-migration source RAID apparatus #S. The acquiring unit 802 acquires inquiry data, which is a response to the command, from the data-migration source RAID apparatus #S. In this manner, the acquiring unit 802 can acquire inquiry data, which is a response to an inquiry (standard) command issued from an apparatus without security permission.

In this case, the setting unit 803 acquires, for example, data of the byte 0 part of the inquiry data that is acquired by the acquiring unit 802 as the result of issue of the inquiry (standard) command including the WWN “#N” of the data migration destination RAID apparatus #D by the acquiring unit 802. The setting unit 803 identifies the acquired data of the byte 0 part, as data set in the data-migration source RAID apparatus #S as host-specific setting information for a case of issue of a command from an apparatus without security permission. The setting unit 803 sets the acquired data in the byte 0 of inquiry response (without Security Permission) field of the host-specific setting table 700.

In this manner, when an apparatus without security permission issues an inquiry (standard) command to the data-migration destination RAID apparatus #D, the data-migration destination RAID apparatus #D can generate inquiry data including set host-specific setting information and send the generated inquiry data to the apparatus without security permission. Thus, the data-migration destination RAID apparatus #D can send a response to the apparatus without security permission in the same manner as the data-migration source RAID apparatus #S does.

When a given memory area among the memory areas of the data-migration source RAID apparatus #S is reserved by the host apparatus #A, the acquiring unit 802 may issue to the data-migration source RAID apparatus #S, a command inquiring whether a storage device including the given memory area is available. The command is issued, using, for example, the WWN “#N1” of the data-migration destination RAID apparatus #D. The acquiring unit 802 acquires a response to the command, from the data-migration source RAID apparatus #S. The given memory area is, for example, a logical volume of the data-migration source RAID apparatus #S. The storage device including the memory area is, for example, a device implementing the logical volume (e.g., disk device 320).

For example, the acquiring unit 802 sets the WWN “#A1” of the host apparatus #A onto the initiator port of the data-migration destination RAID apparatus #D. The acquiring unit 802 then issues a reserve command including the WWN “#A1” to the data-migration source RAID apparatus #S. As a result, the data-migration source RAID apparatus #S is reserved by the host apparatus #A. Subsequently, the acquiring unit 802 sets the WWN “#N” of the data-migration destination RAID apparatus #D onto the initiator port of the data-migration destination RAID apparatus #D. The acquiring unit 802 then issues a test unit ready command including the WWN “#N” to the data-migration source RAID apparatus #S. The acquiring unit 802 acquires a response from the data-migration source RAID apparatus #S.

As a result, when a different apparatus issues a test unit ready command for the logical volume reserved by the host apparatus #A, the setting unit 803 can determine whether to send a reservation conflict response.

In this case, the setting unit 803, for example, determines whether the acquiring unit 802 has acquired a reservation conflict response. Based on the result of the determination, when a different apparatus has issued the test unit ready command for the logical volume reserved by the host apparatus #A, the setting unit 803 determines whether to send a reservation conflict response. The setting unit 803 sets in the reservation conflict response for test unit ready field of the host-specific setting table 700, information indicating whether to send a reservation conflict response.

In a given case, for example, after the host apparatus #A reserves a logical volume of the data-migration destination RAID apparatus #D, an apparatus different from the host apparatus #A may issue a test unit ready command for the logical volume. In such a case, the data-migration destination RAID apparatus #D determines whether to send reservation conflict to the apparatus different from the host apparatus #A.

The data-migration destination RAID apparatus #D may implement a process of data migration from the data-migration source RAID apparatus #S to the data-migration destination RAID apparatus #D, through the memory unit 801, the acquiring unit 802, and the setting unit 803. A specific example of the data migration process implemented through the memory unit 801, the acquiring unit 802, and the setting unit 803 will be described. The function of the memory unit 801 has been described above, and is therefore omitted in the following description.

For example, using the WWN “#A” of the host apparatus #A, the acquiring unit 802 issues to the data-migration source RAID apparatus #S, a command requesting data stored in a logical volume assigned to the host apparatus #A. The acquiring unit 802 acquires a response to the command, from the data-migration source RAID apparatus #S.

For example, the acquiring unit 802 extracts from the migration setting file 400, the WWN “#A1” of the host apparatus #A that has been using the data-migration source RAID apparatus #S, and sets the WWN “#A1” of the host apparatus #A onto the initiator port in the data migration destination RAID apparatus #D. The acquiring unit 802 refers to the migration setting file 400 and identifies a logical volume assigned to the host apparatus #A.

The acquiring unit 802 issues to the data-migration source RAID apparatus #S, a command that includes the WWN “#A1” and information indicating the identified logical volume and that requests data stored in the identified logical volume. As a result, the data-migration source RAID apparatus #S sends a response including the data stored in the logical volume assigned to the host apparatus #A in the data-migration source RAID apparatus #S, to the data migration destination RAID apparatus #D.

The acquiring unit 802 acquires the response including the data stored in the logical volume assigned to the host apparatus #A in the data-migration source RAID apparatus #S, from the data-migration source RAID apparatus #S. As a result, the setting unit 803 can extract the data stored in the memory area assigned to the host apparatus #A in the data-migration source RAID apparatus #S, from the response acquired by the acquiring unit 802 and migrate the extracted data to the data-migration destination RAID apparatus #D.

The setting unit 803 writes the data included in the response acquired by the acquiring unit 802, to a memory area assigned to the host apparatus #A among the memory areas of the data-migration destination RAID apparatus #D. For example, the setting unit 803 refers to the migration setting file 400 and identifies a logical volume of the data-migration destination RAID apparatus #D that corresponds to the logical volume of the data-migration source RAID apparatus #S in which the data included in the response acquired by the acquiring unit 802 has been stored and that is to be assigned to the host apparatus #A. The setting unit 803 then writes the data included in the response acquired by the acquiring unit 802, to the identified logical volume. In this manner, the setting unit 803 can migrate the data from the data-migration source RAID apparatus #S to the data-migration destination RAID apparatus #D.

A specific example of setting of host-specific setting information by the data-migration destination RAID apparatus #D will be described with reference to FIGS. 9 to 16.

FIGS. 9, 10, 11, 12, 13, 14, 15, and 16 are explanatory diagrams of a specific example of setting of the host-specific setting information by the data-migration destination RAID apparatus #D. FIG. 9 depicts a state of the storage system 200 before setting of the host-specific setting information by the data-migration destination RAID apparatus #D.

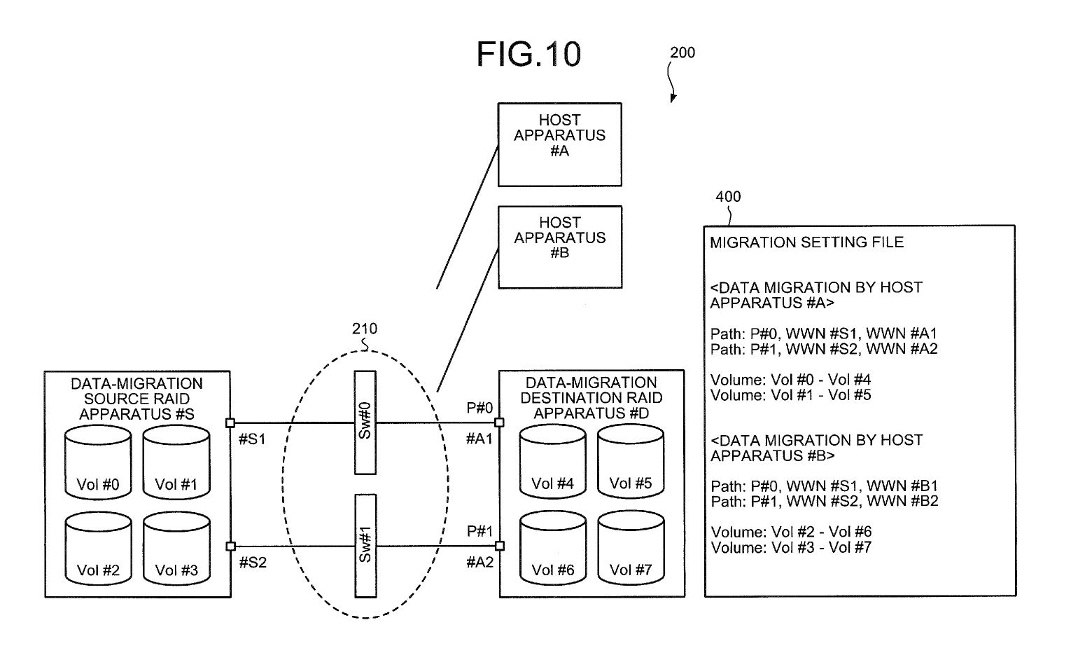

In FIG. 9, the data-migration source RAID apparatus #S is connected to the host apparatus #A and to the host apparatus #B via the network 210. The data-migration source RAID apparatus #S assigns the logical volumes Vol#0 and Vol#1 thereof to the host apparatus #A, and assigns the logical volumes Vol#2 and Vol#3 thereof to the host apparatus #B. FIG. 10 depicts preparation for replacement work by the worker of replacing the data-migration source RAID apparatus #S with the data-migration destination RAID apparatus #D.

In FIG. 10, for the replacement work, the worker causes the data-migration destination RAID apparatus #D to form the logical volumes Vol#4 to Vol#7 to which data stored in the logical volumes Vol#0 to Vol#3 of the data-migration source RAID apparatus #S is to be migrated. The worker then breaks the connection between the data-migration source RAID apparatus #S and the host apparatuses #A and #B, and connects data-migration source RAID apparatus #S to the data-migration destination RAID apparatus #D. The worker inputs a setting process start instruction into the storage apparatus 102.

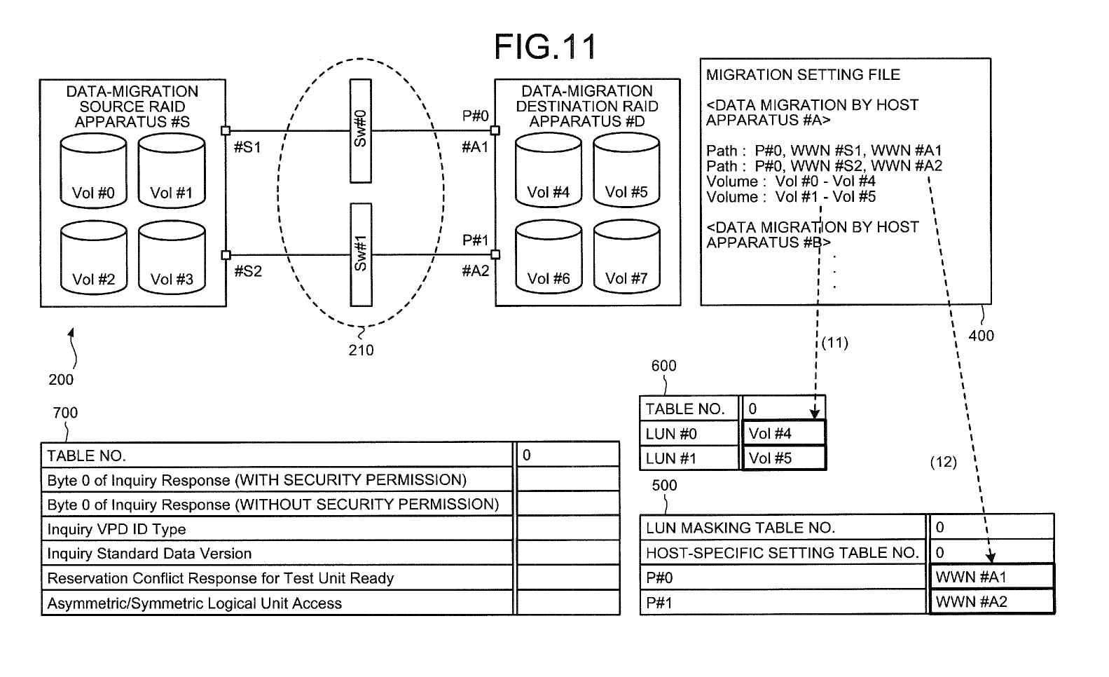

The data-migration destination RAID apparatus #D stores the migration setting file 400 including information on data migration by the host apparatus #A and information on data migration by the host apparatus #B. The migration setting file 400 is input by, for example, the worker. FIGS. 11 to 16 depict a flow of setting of the host-specific setting information.

In FIG. 11, (11) the data-migration destination RAID apparatus #D refers to the migration setting file 400, identifies the logical volumes Vol#4 and Vol#5 to be assigned to the host apparatus #A, and stores the identifiers for the identified logical volumes in the LUN masking table 600. As a result, the data-migration destination RAID apparatus #D can perform control to allow the host apparatus #A to access the logical volumes Vol#4 and Vol#5, by referring to the LUN masking table 600. The data-migration destination RAID apparatus #D can also perform control to enable a host apparatus other than the host apparatus #A to access the logical volumes Vol#4 and Vol#5.

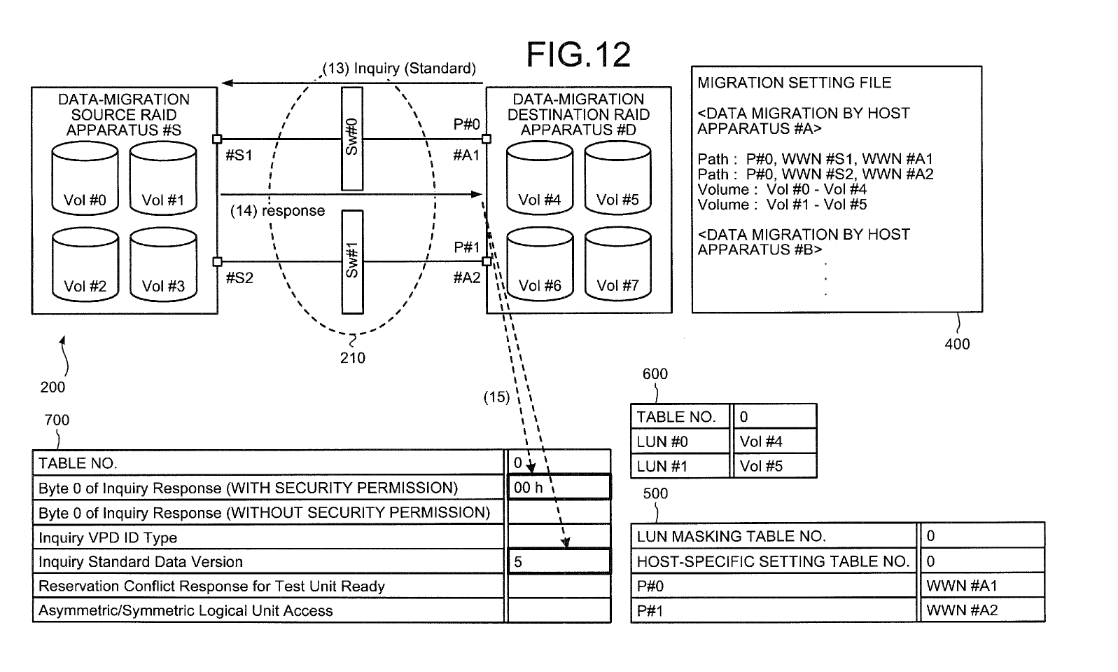

(12) The data-migration destination RAID apparatus #D identifies the WWN of the host apparatus #A, by referring to the migration setting file 400, and stores the WWN to be set onto each port of the data-migration destination RAID apparatus #D in the host table 500. Thus, the data-migration destination RAID apparatus #D can issue an SCSI command by emulating the host apparatus #A, by referring to the host table 500. FIG. 12 will be described.

In FIG. 12, (13) the data-migration destination RAID apparatus #D issues an inquiry (standard) command to the data-migration source RAID apparatus #S. (14) The data-migration source RAID apparatus #S sends inquiry data to the data-migration destination RAID apparatus #D, as a response to the inquiry (standard) command.

(15) The data-migration destination RAID apparatus #D extracts data “00h” of the byte 0 part from the inquiry data. “h” is a suffix indicating that “00” is hexadecimal figures. The data “00h” of the byte 0 part, therefore, represents data created by combining together peripheral qualifier “000” and peripheral device type “00000”.

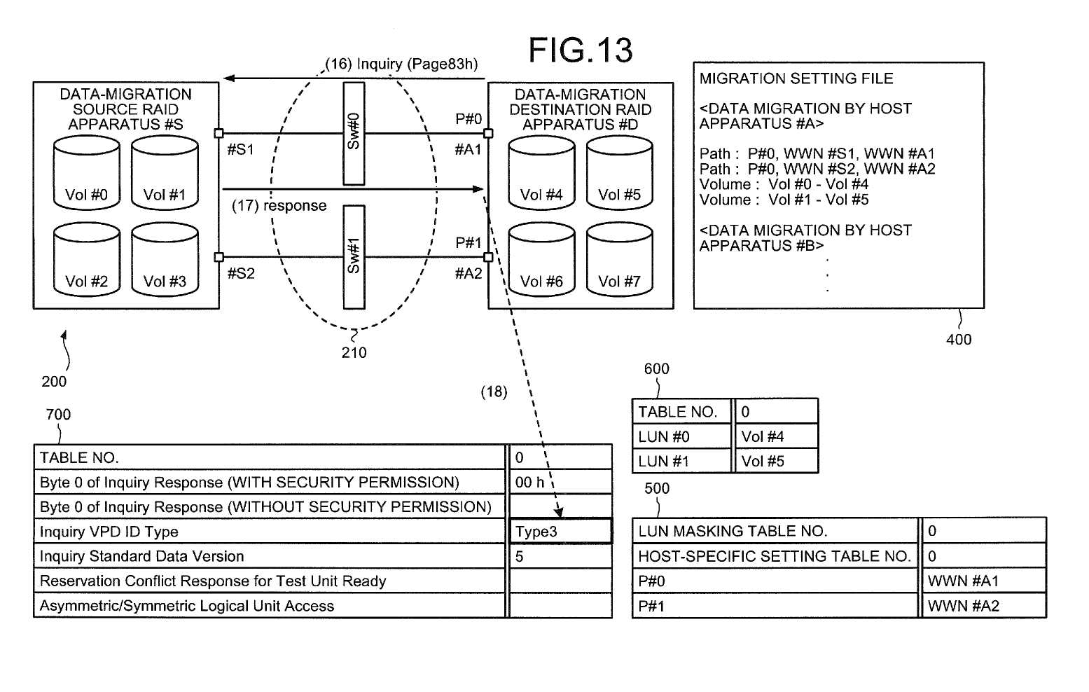

The data-migration destination RAID apparatus #D stores the extracted “00h” into the byte 0 of inquiry response (with security permission) field in the host-specific setting table 700. The data-migration destination RAID apparatus #D also extracts the ANSI Version part “5” from the inquiry data and stores the extracted “5” into the inquiry standard data version field of the host-specific setting table 700. FIG. 13 will be described.

In FIG. 13, (16) the data-migration destination RAID apparatus #D issues an inquiry (page 83h) command to the data-migration source RAID apparatus #S. (17) The data-migration source RAID apparatus #S sends inquiry data to the data-migration destination RAID apparatus #D, as a response to the inquiry (page 83h) command.

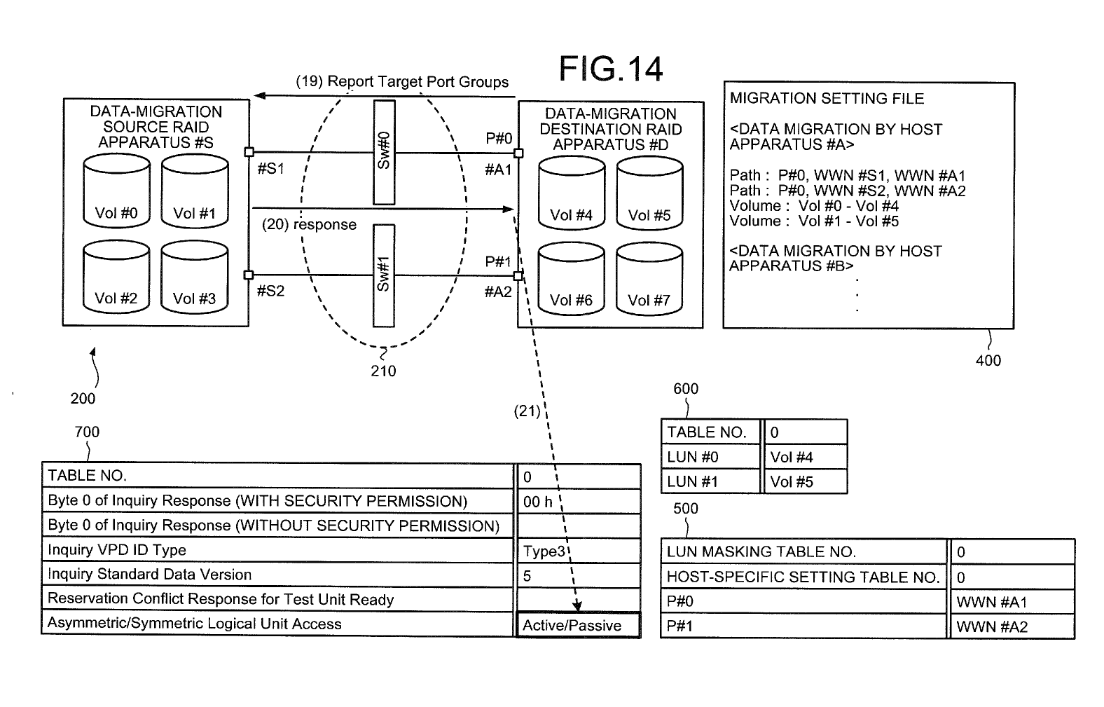

(18) The data-migration destination RAID apparatus #D identifies VPD ID Type “Type 3” of the inquiry data and stores identified “Type 3” in the Inquiry VPD ID Type field of the host-specific setting table 700. FIG. 14 will be described.

In FIG. 14, (19) the data-migration destination RAID apparatus #D issues a report target port groups command to the data-migration source RAID apparatus #S. (20) The data-migration source RAID apparatus #S sends asymmetric access state to the data-migration destination RAID apparatus #D, as a response to the report target port groups command.

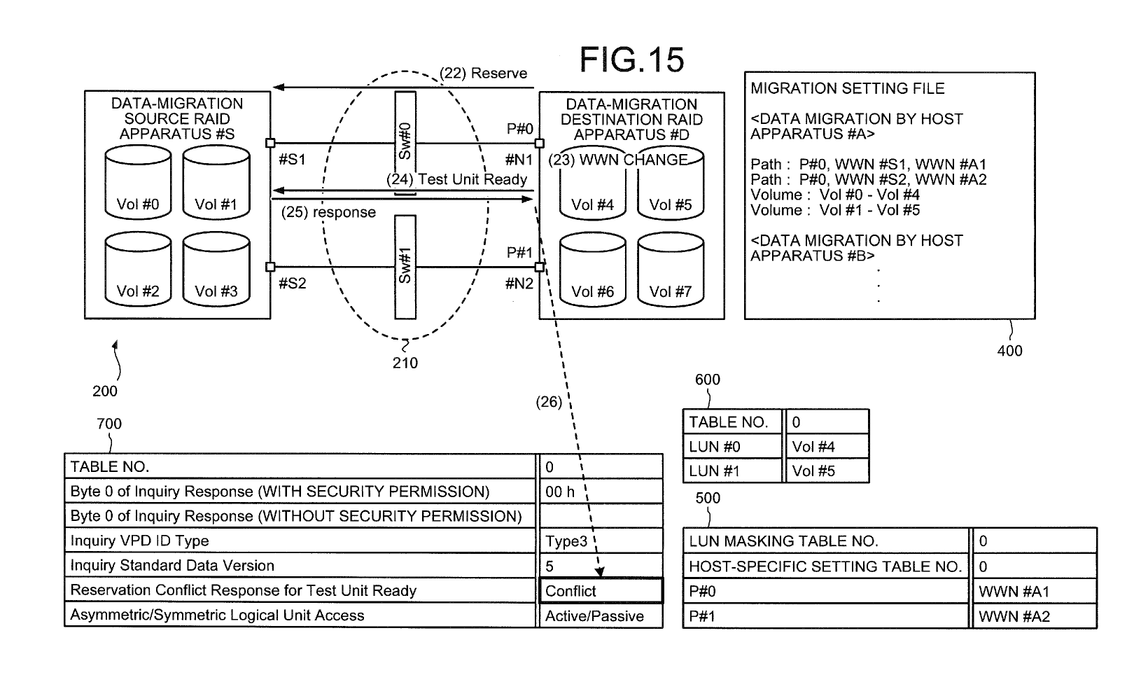

(21) The data-migration destination RAID apparatus #D identifies path information “Active/Passive” indicated by the asymmetric access state. The data-migration destination RAID apparatus #D stores the identified “Active/Passive” into the asymmetric/symmetric logical unit access field of the host-specific setting table 700. FIG. 15 will then be described.

In FIG. 15, (22) the data-migration destination RAID apparatus #D issues a reserve command to the data-migration source RAID apparatus #S. As a result, the data-migration source RAID apparatus #S is reserved by the host apparatus #A.

(23) The data-migration destination RAID apparatus #D sets the WWN “#N1” thereof onto the port P#0. (24) The data-migration destination RAID apparatus #D issues a test unit ready command to the data-migration source RAID apparatus #S. (25) The data-migration source RAID apparatus #S sends a response to the test unit ready command, to the data-migration destination RAID apparatus #D.

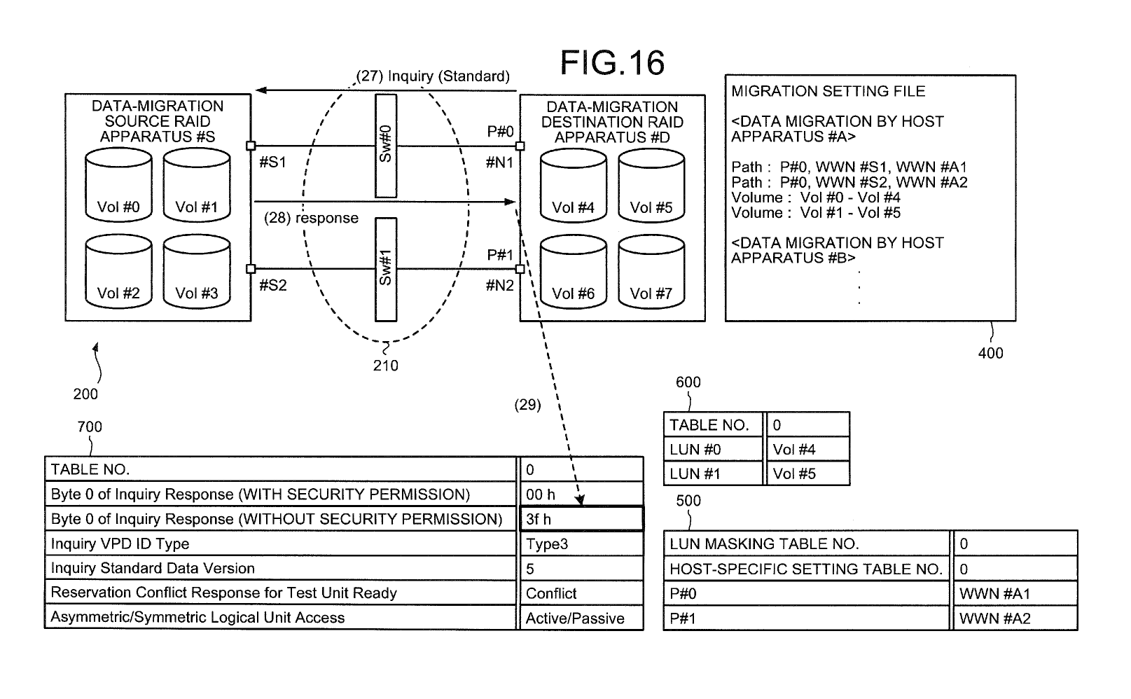

(26) The data-migration destination RAID apparatus #D determines whether the response is a reservation conflict response. The response is determined to be a reservation conflict response in some cases. In such a case, the data-migration destination RAID apparatus #D stores “conflict” in the reservation conflict response for test unit ready field of the host-specific setting table 700. FIG. 16 will be described.

In FIG. 16, (27) the data-migration destination RAID apparatus #D issues an inquiry (standard) command to the data-migration source RAID apparatus #S. (28) The data-migration source RAID apparatus #S sends inquiry data to the data-migration destination RAID apparatus #D, as a response to the inquiry (standard) command.

(29) The data-migration destination RAID apparatus #D extracts data “3fh” of the byte 0 part from the inquiry data. The data-migration destination RAID apparatus #D stores the extracted “3fh” into the byte 0 of inquiry response (without Security Permission) field of the host-specific setting table 700. In this manner, the data-migration destination RAID apparatus #D can set host-specific setting information set in the data-migration source RAID apparatus #S, onto the data-migration destination RAID apparatus #D.

The data-migration destination RAID apparatus #D refers to the migration setting file 400 to identify a logical volume of the data-migration source RAID apparatus #S from which data is migrated and a logical volume of the data-migration destination RAID apparatus #D to which the data is migrated. The data-migration destination RAID apparatus #D then issues to the data-migration source RAID apparatus #S, a command requesting the data in the identified logical volume of the data-migration source RAID apparatus #S, using the WWN “#A” of the host apparatus #A to connect to. The data-migration destination RAID apparatus #D writes data included in a response from the data-migration source RAID apparatus #S, to the identified logical volume of the data-migration destination RAID apparatus #D. In this manner, the data-migration destination RAID apparatus #D can automate data migration.

Subsequently, the worker breaks the connection between the data-migration source RAID apparatus #S and the data-migration destination RAID apparatus #D, and connects the data-migration destination RAID apparatus #D to the host apparatus #A. When the host apparatus #A issues a command, the data-migration destination RAID apparatus #D sends a response to the host apparatus #A, by referring to the host-specific setting information migrated to the data-migration destination RAID apparatus #D.

For example, the host apparatus #A may issue a command including the WWN “#A1” of the host apparatus #A and requesting data stored in the logical volume Vol#4. In this case, the data-migration destination RAID apparatus #D refers to the host table 500 to identify a number in the LUN masking table no. field that corresponds to the WWN “#A1”.

The data-migration destination RAID apparatus #D then refers to the LUN masking table 600 specified by the identified number and identifies the logical volumes Vol#4 and Vol#5 that the host apparatus #A is allowed to use. Because the logical volume Vol#4 is the volume used by the host apparatus #A, according to the command, the data-migration destination RAID apparatus #D sends the data carried by the logical volume Vol#4 to the data-migration destination RAID apparatus #S, as a response.

The host apparatus #A may issue a command including the WWN “#A1” of the host apparatus #A and requesting device information of the logical volume Vol#4. In this case, the data-migration destination RAID apparatus #D refers to the host table 500 to identify a number in the LUN masking table no. field that corresponds to the WWN “#A1”. The data-migration destination RAID apparatus #D then refers to the LUN masking table 600 specified by the identified number and identifies the logical volumes Vol#4 and Vol#5 that the host apparatus #A is allowed to use.

Because the logical volume Vol#4 is the volume used by the host apparatus #A, the data-migration destination RAID apparatus #D refers to the host table 500 and identifies a number in the host-specific setting table no. field that corresponds to the WWN “#A1”. Referring to the host-specific setting table 700 specified by the identified number, the data-migration destination RAID apparatus #D sends a response including the device information of the logical volume Vol#4 to the data-migration source RAID apparatus #S, according to the command.

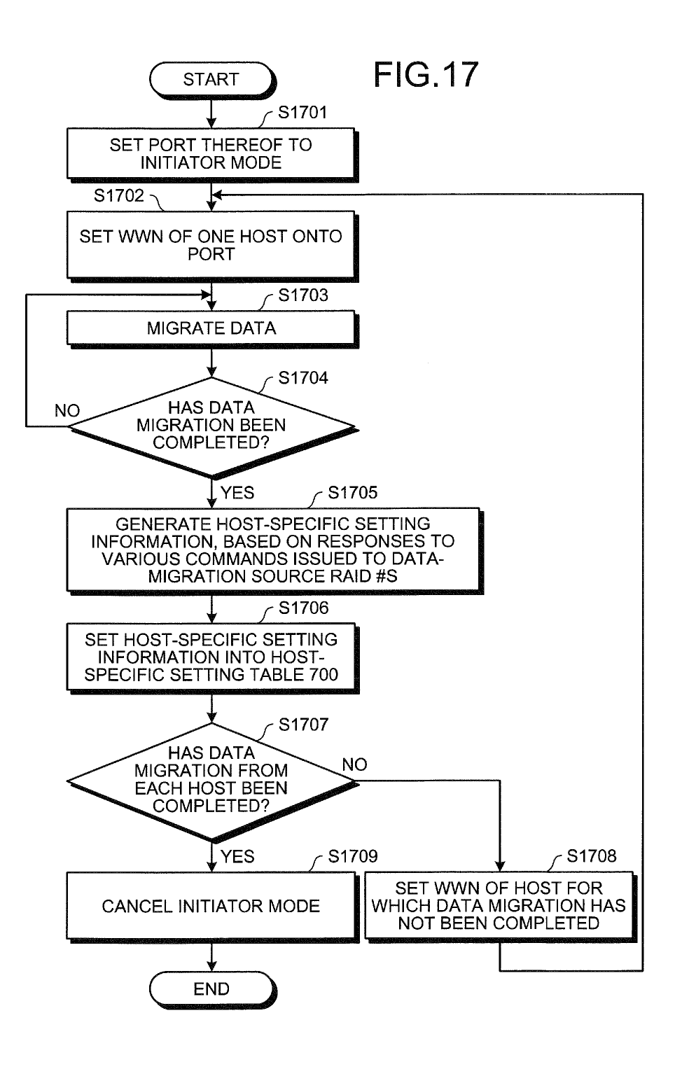

An example of a procedure of a data migration process by the data-migration destination RAID apparatus #D will be described with reference to FIG. 17. The data migration process is a process for achieving the setting of host-specific setting information by the data-migration destination RAID apparatus #D depicted in FIGS. 9 to 16.

FIG. 17 is a flowchart of an example of a procedure of the data migration process by the data-migration destination RAID apparatus #D. In FIG. 17, the data-migration destination RAID apparatus #D sets the port thereof to the initiator mode (step S1701).

The data-migration destination RAID apparatus #D refers to the migration setting file 400 and sets the WWN of one of multiple hosts onto the port of the data-migration destination RAID apparatus #D (step S1702). The data-migration destination RAID apparatus #D refers to the migration setting file 400 and issues to the data-migration destination RAID source #S, a command requesting data stored in the data-migration destination RAID source #S and thereby, migrates the data (step S1703).

The data-migration destination RAID apparatus #D then determines whether data migration has been completed (step S1704). If the data migration has not been completed (step S1704: NO), the data-migration destination RAID apparatus #D returns to step S1703.

If the data migration has been completed (step S1704: YES), the data-migration destination RAID apparatus #D generates host-specific setting information, based on responses to various commands issued to the data-migration source RAID #S (step S1705). The data-migration destination RAID apparatus #D sets the generated host-specific setting information into the host-specific setting table 700 (step S1706).

The data-migration destination RAID apparatus #D determines whether data migration from each host has been completed (step S1707). If data of which migration from a host has not been completed is present (step S1707: NO), the data-migration destination RAID apparatus #D sets onto the port of the data-migration destination RAID apparatus #D, the WWN of the host for which data migration has not been completed (step S1708), and returns to step S1702.

When data migration from each host has been completed (step S1707: YES), the data-migration destination RAID apparatus #D cancels the initiator mode of the port (step S1709), and ends the data migration process.

As a result, the data-migration destination RAID apparatus #D can set host-specific setting information onto the data-migration destination RAID apparatus #D. Following the data migration process, the worker connects the data-migration destination RAID apparatus #D to the host apparatus #A. Thus, the host apparatus #A can use the migration destination RAID apparatus #D in the same manner as the migration source RAID apparatus #S does.

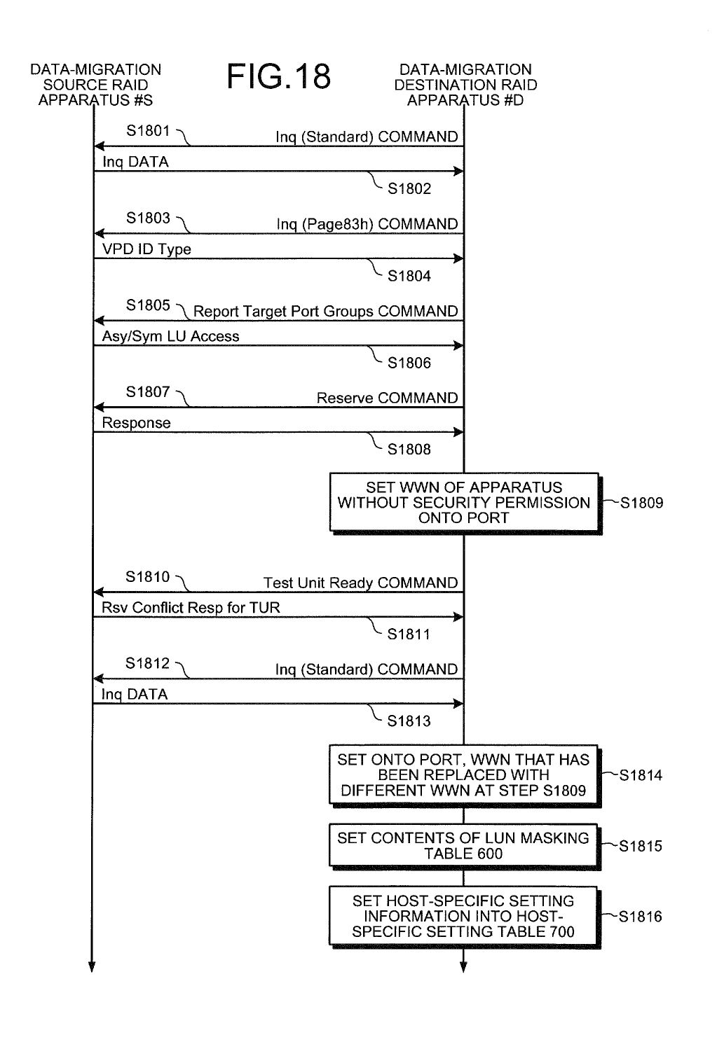

A process of setting the host-specific setting table 700 that is executed at steps S1705 and S1706 will be described with reference to FIG. 18.

FIG. 18 is a sequence diagram of an example of a procedure of a process of setting the host-specific setting table 700. In FIG. 18, Inquiry may be abbreviated as “Inq”, asymmetric/symmetric logical unit access may be abbreviated as “Asy/Sym LU Access”, and reservation conflict response for test unit ready may be abbreviated as “rsv conflict resp for TUR”.

In FIG. 18, the data-migration destination RAID apparatus #D issues an inquiry (standard) command to the data-migration source RAID apparatus #S (step S1801). When receiving the inquiry (standard) command, the data-migration source RAID apparatus #S sends inquiry data to the data-migration destination RAID apparatus #D (step S1802).

The data-migration destination RAID apparatus #D then issues an inquiry (page 83h) command to the data-migration source RAID apparatus #S (step S1803). Upon receiving the inquiry (page 83h) command, the data-migration source RAID apparatus #S sends a response including the VPD ID type to the data-migration destination RAID apparatus #D (step S1804).

The data-migration destination RAID apparatus #D then issues an report target port groups command to the data-migration source RAID apparatus #S (step S1805). Upon receiving the report target port groups command, the data-migration source RAID apparatus #S sends a response including Asy/Sym LU access to the data-migration destination RAID apparatus #D (step S1806).

The data-migration destination RAID apparatus #D then issues a reserve command to the data-migration source RAID apparatus #S (step S1807). Upon receiving the reserve command, the data-migration source RAID apparatus #S sends to the data-migration destination RAID apparatus #D, a response confirming reservation (step S1808). The data-migration destination RAID apparatus #D sets the WWN of an apparatus without security permission onto the port of data-migration destination RAID apparatus #D (step S1809).

The data-migration destination RAID apparatus #D then issues a test unit ready command to the data-migration source RAID apparatus #S (step S1810). Upon receiving the test unit ready command, the data-migration source RAID apparatus #S sends a response including rsv conflict resp for TUR to the data-migration destination RAID apparatus #D (step S1811).

The data-migration destination RAID apparatus #D then issues an inquiry (standard) command to the data-migration source RAID apparatus #S (step S1812). When receiving the inquiry (standard) command, the data-migration source RAID apparatus #S sends inquiry data to the data-migration destination RAID apparatus #D (step S1813).

The data-migration destination RAID apparatus #D then sets onto the port, a WWN that has been replaced with a different WWN at step S1809 (step S1814). The data-migration destination RAID apparatus #D refers to the migration setting file 400 and sets the contents of the LUN masking table 600 (step S1815).

The data-migration destination RAID apparatus #D then checks each response to identify host-specific setting information, and sets the identified host-specific setting information into the host-specific setting table 700 (step S1816), after which the data-migration destination RAID apparatus #D ends the setting process. In this manner, the data-migration destination RAID apparatus #D can make the host-specific setting table 700.

As described above, using identification information of the host apparatus, the data-migration destination RAID apparatus #D of the embodiments can acquire from the data-migration source RAID apparatus #S, a response that is output from the data-migration source RAID apparatus #S when the host apparatus issues a command. The data-migration destination RAID apparatus #D, using the acquired response, can identify host-specific setting information set in the data-migration source RAID apparatus #S and set the identified host-specific setting information onto the data-migration destination RAID apparatus #D.

Thus, the data-migration destination RAID apparatus #D emulating the host apparatus extracts host-specific setting information from the data-migration source RAID apparatus #S and thereby, automatically sets the host-specific setting information. As a result, work load on the worker during replacement work is reduced and erroneous setting of parameter information is prevented, making the replacement work more efficient.

Even if the worker is not familiar with work for setting the host-specific setting information, the worker can cause the data-migration destination RAID apparatus #D to set the host-specific setting information by inputting a setting process start instruction to the data-migration destination RAID apparatus #D. The data-migration source storage apparatus 101 does not need to be provided with a new function. Therefore, the burden on the worker and cost can be reduced, compared to the case where each of the data migration source and data-migration destination storage apparatuses is provided with a function of automatically setting the host-specific setting information. The host apparatus can use the data-migration destination storage apparatus in the same manner as the data-migration source RAID apparatus #S does.

Using identification information of the different apparatus different from the host apparatus, the data-migration destination RAID apparatus #D can acquire from the data-migration source RAID apparatus #S, a response that is output from the data-migration source RAID apparatus #S when a different apparatus issues a command. The data-migration destination RAID apparatus #D, using the acquired response, can identify host-specific setting information set in the data-migration source RAID apparatus #S and set the identified host-specific setting information onto the data-migration destination RAID apparatus #D. In this manner, the data-migration destination RAID apparatus #D can set onto the data-migration destination RAID apparatus #D, host-specific setting information corresponding to a different apparatus without security permission.

The data-migration destination RAID apparatus #D can issue to the data-migration source RAID apparatus #S, an inquiry (standard) command including identification information of the host apparatus. As a result, the data-migration destination RAID apparatus #D can identify host-specific setting information written to inquiry data that is to be sent to an apparatus with security permission.

The data-migration destination RAID apparatus #D can issue to the data-migration source RAID apparatus #S, an inquiry (standard) command including identification information related to another apparatus. As a result, the data-migration destination RAID apparatus #D can identify host-specific setting information written to inquiry data that is to be sent to the other apparatus without security permission.

The data-migration destination RAID apparatus #D can issue to the data-migration source RAID apparatus #S, an inquiry (page 83h) command including identification information of the host apparatus. As a result, the data-migration destination RAID apparatus #D can identify VPD Type as host-specific setting information.

The data-migration destination RAID apparatus #D can issue to the data-migration source RAID apparatus #S, an inquiry (standard) command including identification information of the host apparatus. As a result, the data-migration destination RAID apparatus #D can identify the version of the SCSI as host-specific setting information.

The data-migration destination RAID apparatus #D can issue a reserve command including identification information of the host apparatus to the data-migration source RAID apparatus #S and thereby, reserve a logical volume of the data-migration source RAID apparatus #S. The data-migration destination RAID apparatus #D can issue a test unit ready command including identification information of a different apparatus, to the data-migration source RAID apparatus #S. As a result, when a logical volume of the data-migration destination RAID apparatus #D is reserved, the data-migration destination RAID apparatus #D can determine whether to send reservation conflict as a response.

The data-migration destination RAID apparatus #D can issue to the data-migration source RAID apparatus #S, a report target port groups command including identification information of the host apparatus. As a result, the data-migration destination RAID apparatus #D can identify a method of using a communication path, as host-specific setting information.

The setting method described in the present embodiment may be implemented by executing a prepared program on a computer such as a personal, computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According one aspect of the embodiments, the work of setting information for an information processing apparatus connected to a storage apparatus becomes more efficient.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A first storage apparatus to which data stored in a second storage apparatus connected to the first storage apparatus is migrated via a network, the first storage apparatus comprising:
a memory unit that stores first identification information of a first information processing apparatus connected to the second storage apparatus via the network; and
a processor configured to:
issue to the second storage apparatus, a command that is issued from the first information processing apparatus to the second storage apparatus, using the first identification information stored in the memory unit, and acquire from the second storage apparatus, a response to the command; and
associate based on the response and set in the first storage apparatus, the first identification information and parameter information of the first information processing apparatus corresponding to the command.

2. The storage apparatus according to claim 1, wherein
the memory unit stores second identification information different from the first identification information, wherein
the processor, using the second identification information, issues a command to the second storage apparatus and acquires from the second storage apparatus, a response to the command, and
the processor associates based on the response and sets in the first storage apparatus, the second identification information and parameter information of a second information processing apparatus that is different from the first information processing apparatus and corresponds to the command.

3. The storage apparatus according to claim 1, wherein
the processor, using the first identification information, issues to the second storage apparatus, a command requesting device information of a storage device that includes a memory area assigned to the first information processing apparatus among memory areas of the second storage apparatus and acquires from the second storage apparatus, a response to the command.

4. The storage apparatus according to claim 1, wherein
the processor, using the first identification information, issues to the second storage apparatus, a command requesting data stored in a memory area assigned to the first information processing apparatus among memory areas of the second storage apparatus and acquires from the second storage apparatus, a response to the command, and
the processor writes to a memory area assigned to the first information processing apparatus among memory areas of the first storage apparatus, data included in the response.

5. The storage apparatus according to claim 1, wherein
the processor, using the first identification information, issues to the second storage apparatus, a command requesting information of a standard of an interface used for communication between the second storage apparatus and the first information processing apparatus and acquires from the second storage apparatus, a response to the command.

6. The storage apparatus according to claim 1, wherein
the processor, using the identification information, issues to the second storage apparatus, a command requesting device information of the second storage apparatus and acquires from the data-migration source storage apparatus, a response to the command.

7. The storage apparatus according to claim 1, wherein
the processor, using the first identification information, issues to the second storage apparatus, a command requesting information of a communication path used for communication between the second storage apparatus and the first information processing apparatus and acquires from the second storage apparatus, a response to the command.

8. The storage apparatus according to claim 2, wherein
the processor, when a given memory area among memory areas of the second storage apparatus is reserved by the first information processing apparatus, uses the second identification information to issue to the second storage apparatus, a command inquiring whether a storage device including the given memory area is available and acquires from the second storage apparatus, a response to the command.

9. A setting method executed by a first storage apparatus to which data stored in a second storage apparatus connected to the first storage apparatus is migrated via a network, the setting method comprising:
issuing to the second storage apparatus, a command that is issued from the first information processing apparatus to the second storage apparatus, using first identification information stored in a memory unit that stores the first identification information of a first information processing apparatus connected to the second storage apparatus via the network, and acquiring from the second storage apparatus, a response to the command; and
associating based on the response and setting in the first storage apparatus, the first identification information and parameter information of the first information processing apparatus corresponding to the command.

10. A computer-readable recording medium storing a setting program that causes a first storage apparatus to which data stored in a second storage apparatus connected to the first storage apparatus is migrated via a network, to execute a process comprising:
issuing to the second storage apparatus, a command that is issued from the first information processing apparatus to the second storage apparatus, using first identification information stored in a memory unit that stores the first identification information of a first information processing apparatus connected to the second storage apparatus via the network, and acquiring from the second storage apparatus, a response to the command; and
associating based on the response and setting in the first storage apparatus, the first identification information and parameter information of the first information processing apparatus corresponding to the command.
